(19) United States
(12) Patent Application Publication
(10) Pub. No.: US 2008/0249873 A1
(43) Pub. Date: Oct. 9, 2008

(54) ADVERTISING SYSTEM AND METHOD

(76) Inventor: Christopher P. Seelinger, Jackson, MI (US)

Correspondence Address: HARNESS, DICKEY & PIERCE, P.L.C., P.O. BOX 828, BLOOMFIELD HILLS, MI, 48303, US

(21) Appl. No.: 12/061,715

(22) Filed: Apr. 3, 2008

Related U.S. Application Data
(60) Provisional application No. 60/921,685, filed on Apr. 3, 2007.

(51) Int. Cl. G06Q 30/00; G06Q 90/00

(52) U.S. Cl. 705/14

(57) ABSTRACT

An advertising system and method is provided and may include a display unit having a memory. The display unit may be mounted in any location and may display images stored in the memory of the display. A customer may pay a predetermined fee to load information into the memory of the display, which may be displayed on the display for a predetermined length of time.

### CROSS-REFERENCE TO RELATED APPLICATIONS

This application claims the benefit of U.S. Provisional Application No. 60/921,685, filed on Apr. 3, 2007. The disclosure of the above application is incorporated herein by reference.

### FIELD

The present disclosure relates to advertising systems and methods and more particularly to a dynamic advertising system and method.

### BACKGROUND

The statements in this section merely provide background information related to the present disclosure and may not constitute prior art.

Prior art advertising systems typically include fixed or static advertisements that have a combination of text and/or graphics. Such static advertisements may include an image and/or text that convey a message to potential customers. While static prior art advertising systems adequately convey a message to potential customers, such prior art systems are cumbersome, lack depth, and require frequent manual updating to change the message displayed. Furthermore, such advertisements do not stimulate or entice a potential customer, as such images lack a dynamic effect and are somewhat ordinary.

Other prior art advertising systems employ a system including a computer, a satellite, and a server that cooperate to display advertising content on display screens. While such systems are an improvement over static advertising displays, such systems are very costly and typically require several networking devices, extensive wiring, multiple drop points to accommodate multiple displays, and a team of personal that updates and maintains the system.

### SUMMARY

An advertising system and method is provided and may include a display unit having a memory. The display unit may be mounted in any location and may display images stored in the memory of the display. A customer may pay a predetermined fee to load information into the memory of the display, which may be displayed on the display for a predetermined length of time.

In another configuration, an advertising system and method may include a display unit having a removable memory. The display unit may be mounted in any location and may display images and video stored in the memory of the display. A customer may pay a predetermined weekly or monthly fee to have information such as classified ads, advertising or an upcoming event at a particular location or venue, loaded onto the memory that is inserted into the display for a predetermined length of time.

The display may be mounted in a public area, such as, for example, a wall or elevator of a retailer such as a shopping mall. Local merchants may pay a predetermined fee to display static or dynamic images on the display for a predetermined length of time in an effort to solicit potential customers at the shopping mall. The fee may be divided between the shopping mall in which the display is mounted and the advertising company who owns and maintains the displays.

In another configuration, the display may be mounted in a public area, such as, for example, a wall, elevator, counter, bathroom, snack bar, hotel lobby, waiting room or ceiling in a retail location or a shopping mall. Local merchants of the shopping mall or local merchants in the surrounding area may pay a predetermined fee to display static or dynamic images on the display for a predetermined length of time in an effort to solicit potential customers for the local retailer or shopping mall.

The advertising company may be responsible for selling advertising space on the display and for loading content from merchants on the display. In this configuration, the advertising company may solicit local merchants to use the display(s) located in the shopping mall, obtain advertising content from the merchant, load the content into the memory of the display, and configure the display to display the image and/or video clip for a predetermined length of time. For example, the images and/or video clips may be displayed a predetermined number of times per day based on the agreement between the advertising company and the merchant. The advertising company may pay the shopping mall a predetermined fee for allowing the display to be mounted within the shopping mall. In this regard, the local merchant is able to provide a message to local, potential customers, while the shopping mall is able to generate revenue using otherwise unused space within the shopping mall.

In another configuration, the advertising company may be responsible for selling advertising space on the display and for loading content from merchants on the display. In this configuration, the advertising company solicits local merchants to use the display(s) located in a retail establishment such as, for example, a coffee shop, bowling alley, doctor/dentist office, ski resort, tire/automotive center, museum, art gallery, bingo hall, banking center, college university, sporting-goods store, restaurant, bakery, family-fun center, ice skating rink, visitor bureau, fitness center, emergency room, car wash, country club, hair salon/day spa, stadium, hardware store, non-profit organization, quick change oil service center or shopping mall. The advertising company obtains advertising content from the merchant or creates the content for the merchant, loads the content into the memory of the display, and configures the display to display the image and/or video clip for a predetermined length of time (i.e., a predetermined number of times per day, per week and/or per month) based on the agreement between the advertising company and the local merchant. The advertising company may pay the retailer or shopping mall a predetermined fee, or give the retailer or shopping mall free advertising for allowing the display to be mounted within the retail location. In this regard, the local merchant is able to provide a message to local, potential customers, while the retailer or shopping mall is able to generate revenue using otherwise unused space within the retail location.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic representation of an advertising system in accordance with the principals of the present teachings; and

FIG. 2 is a flow chart depicting an advertising system and method in accordance with the principals of the present teachings.

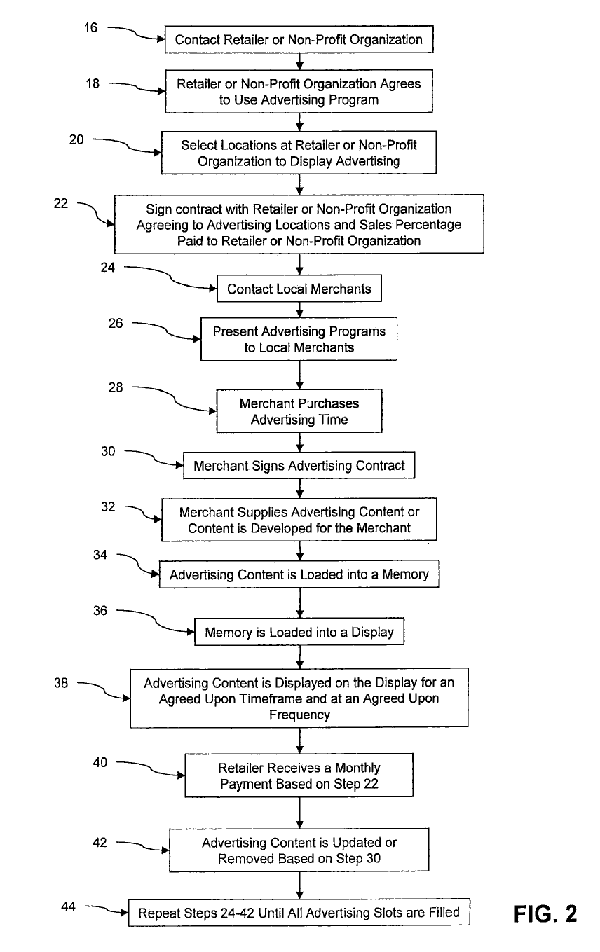

### DETAILED DESCRIPTION

The following description is merely exemplary in nature and is not intended to limit the present disclosure, application, or uses. It should be understood that throughout the drawings, corresponding reference numerals indicate like or corresponding parts and features.

With reference to the figures, an advertising system and method is provided. The advertising system 10 utilizes otherwise unutilized space in a public space such as, for example a retail location or shopping mall to display advertising content to people in the retail location or shopping mall. While the advertising system 10 of the present teachings will be described hereinafter and shown in the drawings as being associated with a retailer such a shopping mall or coffee shop, the advertising system 10 may be used to dynamically display other advertising content in other venues. For example, the advertising system 10 of the present teachings may be used in an art gallery or museum to display works of art in a looping fashion, thereby obviating the need to display multiple works of art for a featured artist and thus conserving wall space in the art gallery or museum.

The advertising system 10 may include at least one display 12 that displays advertisements in a shopping mall/retail store. In one configuration, the display 12 may include an LCD/TV screen integrated with a solid state no moving part video player or an external solid state no moving part video player that can be connected to an LCD/TV or LCD monitor, that displays content from a standard compact flash card or an secure digital card, looping content.

The display 12 may include a memory 14 that stores content from an advertiser. The memory 14 may include a compact-flash card or secure digital-flash card that stores file types including MPEG1, 2, or 4 files, VOB files, AVI files, MP3 files, and/or standard and progressive JPEG files. In either configuration, the memory 14 permits looping content such that advertisements of various merchants may be loaded together and looped (i.e., displayed in a looping fashion) in a predetermined sequence. The advertisement content may include both static and dynamic content and may include advertisements of varying length and type. For example, a ten-second static advertisement may be loaded between a twenty-second dynamic (i.e., video) advertisement and a thirty-second combined static and dynamic advertisement.

The memory 14 may loop the advertisement in a predetermined sequence, or, alternatively, may randomly configure the advertising content to permit looping different sequences or start at a predetermined time and end at a predetermined time. In either configuration, the memory 14 may ensure that each merchant is given an appropriate length of advertisement (i.e., rotations per month, for example) based on the fee paid by the merchant.

The advertising content (i.e., graphical art) may be received from the merchant and may be done by a graphic art department based on actual products and/or flat art. Dynamic content (i.e., a video, for example) and/or an audio file may be included to enhance the advertising content. The advertising content stored in the memory 14 and displayed on the display 12 may be created on a computer or a video camera and be stored in the memory 14 (i.e., on a CF or SD card, for example). Alternatively, a merchant may supply the advertising content if the merchant already has a commercial developed. Under such circumstances, the commercial may be loaded onto a compact disc or DVD in a predetermined file format. The advertising company may re-encode the file into a mpeg file, for example, and then store the file on the memory 14 of the display 12.

The memory 14 (i.e., a CF or SD card) disposed in the display 12 may be replaced with another memory device 14 (i.e., another CF or SD card, for example) to update advertising content stored within and displayed by the display 12. Alternatively, the memory 14 may be removed, updated with new and/or additional advertising content, and then reinserted into the display 12. In either configuration, once updated, the display 12 plays the new content and loops the content for a predetermined length of time. The above device allows the display 12 to be easily updated and therefore makes it affordable and easy for local-area businesses to dynamically advertise in a public space.

In operation, a CF/SD memory card having advertising content loaded thereon is inserted into the display 12. Upon supplying power to the display 12, the content stored in the memory 14 is automatically displayed on the display 12. Each segmented advertisement stored in the memory 14 may be limited to a set time such as, for example, thirty-seconds. Each advertisement may play for the set time period then start over at the beginning of the loop. Each unit may also be programmed to adhere to an external condition, such as, for example, shopping mall/retail store hours of operation. Limiting the display of advertisements during hours of operation of a shopping mall in which the display 12 is mounted ensures maximum exposure of advertising content while concurrently minimizing an amount of energy consumed by the display 12.

Supplying the display 12 with a removable memory 14 obviates the need for costly wiring, extra equipment, personnel and expensive installation of each display 12. Therefore, the displays 12 can be mounted on any wall or positioned on any working surface such as a counter near a register or display rack in a retail environment.

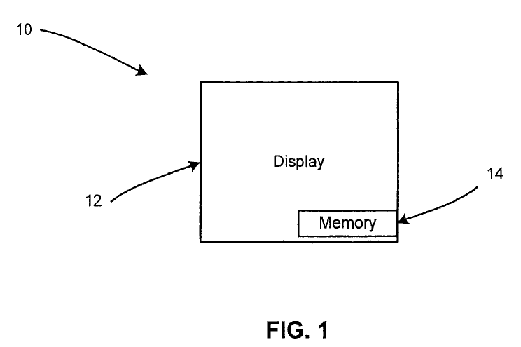

With reference to FIG. 1, the advertising method of the present teachings will be described in detail. An advertising company may procure a public area on which to mount a display 12. For example, the advertising company may agree to pay a retailer such as a shopping mall or bowling alley a predetermined fee, or give the retailer free advertising for mounting a display or displays 12 on a wall or counter within the retail location. The fee may be a set fee or a percentage of advertising revenue collected by the advertising company from merchants that wish to display content on the display within the retail location. Alternatively or additionally, the advertising company may give the retailer free advertising for a predetermined length of time on displays in retail locations.

The advertising company first contacts a local retailer or non-profit organization at 16 to determine if the retailer/non-profit organization is interested in mounting displays 12 within its retail location/place of business. The retailer/non-profit organization may agree to allow the advertising company to mount the displays within the retail establishment at 18. Once the retailer agrees to have a display 12 mounted at the retail location, the advertising company negotiates with the retailer on where to mount the displays 12 within the retail location at 20. The advertising company then negotiates with the retailer to pay the retailer a predetermined fee, a percentage of all revenue collected by the advertising company from monies received from other local merchants, or negotiates free advertising to the retailer for a predetermined length of time.

The advertising company solicits local merchants within a predetermined radius of the retail or shopping mall to purchase advertising spots on the display 12 at 24. The advertising company reviews various options with the merchant including possible content and content creation that may be displayed on the displays 12. Specifically, the advertising company reviews the various costs associated with the different types of advertising content (i.e., static versus dynamic and/or silent versus audible) as well as the different costs associated with the length of time the advertisement is shown and the frequency with which it is shown 26. The merchant may agree to pay for advertising in the retail location or shopping mall on the displays 12 disposed within the retail/shopping mall location at 28. The advertising company then has the local merchant sign an advertising contract for a predetermined length of time.

In one configuration, the merchant agrees to pay for a minimum of one week of advertising and up to one year of advertising for a time slot of ten, fifteen, or thirty seconds. The content of the advertisement may be supplied by the merchant to the advertising company at 32, or the advertising company may create the advertisement for the merchant. Once the advertisement company has received the content from the merchant and it is approved by the merchant, the advertising company may load the content onto the memory 14 of the display 12 at 34.

Once the memory 14 of the displays 12 are populated with advertisements from various merchants, the memory 14 are loaded into respective displays 12 and are looped for the duration of each individual contract (i.e., the contract between the advertising company and the merchant) at 36. The advertisement content is played on the display 12 for a predetermined time period and for a predetermined length of time based on the agreement between the advertising company and the merchant at 38.

The advertising company pays the retailer/shopping mall a monthly predetermined fee or a percentage of advertising sales and/or gives retailer/shopping mall free advertising based on the agreement between the advertising company and retailer/shopping mall at 40.

The memory 14 of each display 12 may be updated weekly or monthly following the completion of the advertising contract between the advertising company and the local merchant at 42. The above process is continually repeated until all advertisement slots are filled at 44.

What is claimed is:

1. A method comprising:
contacting a retailer;
locating a display within a public space of said retailer;
contacting merchants within a predetermined radius of said retailer;
displaying advertisements for said merchants on said display at said retailer;
collecting payment from said merchants for displaying said advertisements on said display at said retailer; and
displaying an advertisement advertising a business of said retailer on said display along with said advertisements of said merchants.

2. The method of claim 1, further comprising storing said advertisements of said merchants on a memory.

3. The method of claim 2, further comprising inserting said memory into said display.

4. The method of claim 1, further comprising looping said advertisements of said merchants and said advertisement of said retailer for a predetermined length of time.

5. The method of claim 1, further comprising paying said retailer for allowing said display to be mounted within said public space.

6. A method comprising:
contacting a non-profit organization;
locating a display within a public space of said non-profit organization;
contacting merchants within a predetermined radius of said non-profit organization;
displaying advertisements for said merchants on said display at said non-profit organization;
collecting payment from said merchants for displaying said advertisements on said display at said non-profit organization; and
displaying an advertisement advertising a business of said non-profit organization on said display along with said advertisements of said merchants.

7. The method of claim 6, further comprising storing said advertisements of said merchants on a memory.

8. The method of claim 7, further comprising inserting said memory into said display.

9. The method of claim 6, further comprising looping said advertisements of said merchants and said advertisement of said non-profit organization for a predetermined length of time.

10. The method of claim 6, further comprising paying said non-profit organization for allowing said display to be mounted within said public space.

11. A method comprising:
mounting a display in a public space of a retailer;
paying said retailer for allowing said display to be mounted in said public area;
contacting merchants within a predetermined radius of said retailer to inquire whether said merchants wish to advertise on said display; and
collecting payment from said merchants for displaying advertisement on said display.

12. The method of claim 11, wherein said payment to said retailer includes providing free advertising on said display to said retailer.

13. The method of claim 11, wherein said payment to said retailer includes paying said retailer a percentage of payment collected from said merchants.

14. The method of claim 11, further comprising storing said advertisements of said merchants on a memory.

15. The method of claim 14, further comprising loading said memory into said display.

16. The method of claim 11, further comprising looping said advertisements of said merchants on said display for a predetermined length of time.
